(19) United States
(12) Patent Application Publication
(10) Pub. No.: US 2005/0265689 A1
(43) Pub. Date: Dec. 1, 2005

(54) Content recording/reproducing apparatus

(76) Inventors: Masanao Yoshida, Osaka (JP); Masayuki Moriaki, Osaka (JP)

Correspondence Address: Gerald T. Bodner, Esq.;BODNER & O'ROURKE, LLP, Suite 108, 425 Broadhollow Road, Melville, NY, 11747, US

(21) Appl. No.: 11/135,961

(22) Filed: May 24, 2005

(30) Foreign Application Priority Data
May 25, 2004 (JP) 2004-155236

(51) Int. Cl. H04N 5/781

(52) U.S. Cl. 386/46; 386/125

(57) ABSTRACT

A voice recorder includes a microphone. When a recording mode is selected, surrounding audio is fetched by the microphone, and corresponding audio data is recorded on a flash memory by an encode/decode IC. When a normal reproducing mode is selected, audio data is reproduced from the flash memory by the encode/decode IC, and a corresponding audio signal is output from a speaker. In the recording mode, the CPU assigns status information indicating “0” to each of one or more partial audio components forming the audio data. However, the status information of the partial audio component reproduced in the normal reproducing mode is updated to “1”. When a skip reproducing mode is selected, a partial audio component of which status information indicates “0” is detected and reproduced from the flash memory.

### BACKGROUND OF THE INVENTION

1. Field of the Invention

The present invention relates to a content recording/reproducing apparatus. More specifically, the present invention relates to a content recording/reproducing apparatus that records a content fetched from outside into a recording medium and reproduces a content from the recording medium.

2. Description of the Prior Art

One example of such a kind of conventional apparatus is disclosed in Japanese Patent Laid-open No. H8-255466 laid-open on Oct. 1, 1996. According to this prior art, when a request for index generation is issued by a user, an index containing position information of audio data is generated, and index-multiplexed audio data containing the generated index and audio data is recorded. The user is free to select a reproducing position by using the index multiplexed on the audio data.

However, free selection of a reproducing position by using the index causes a phenomenon in which unreproduced partial audio data is intermittently left. Such a phenomenon becomes more conspicuous as the number of multiplexed indexes increases, which leads to a decrease in operability.

### SUMMARY OF THE INVENTION

Therefore, it is a primary object of the present invention to provide a novel content recording/reproducing apparatus.

It is another object of the present invention to provide a content recording/reproducing apparatus capable of improving operability.

It is still another object of the present invention to provide a content recording/reproducing apparatus capable of accurately reproducing an unreproduced partial content.

It is further another object of the present invention to provide a content recording/reproducing apparatus capable of accurately deleting an unnecessary partial content accurately.

A content recording/reproducing apparatus according to the present invention comprises: a fetcher for fetching a content; a recorder for recording the content fetched by the fetcher; a first reproducer for reproducing the content recorded by the recorder; an assigner for assigning a first numerical value to each of one or more partial contents forming the content recorded by the recorder prior to a reproducing process by the first reproducer; a first updater for updating the numerical value assigned to a partial content reproduced by the first reproducer, out of the one or more partial contents, to a second numerical value; a detector for detecting a partial content to which the first numerical value is assigned from among the one or more partial contents when a special reproducing mode is selected; and a second producer for reproducing the partial content detected by the detector.

A content is fetched by the fetcher and recorded by the recorder. The recorded content is reproduced by the first reproducer. The assigner assigns the first numerical value to each of one or more partial contents forming the recorded content prior to the reproducing process by the first reproducer. However, the numerical value assigned to the partial content reproduced by the first reproducer is updated by the first updater to the second numerical value. The detector detects the partial content to which the first numerical value is assigned from among the one or more partial contents when the special reproducing mode is selected. The detected partial content is reproduced by the second reproducer.

Therefore, the partial content to which the first numerical value is assigned constitutes a partial content not yet reproduced by the first reproducer. In the special reproducing mode, such an upreproduced partial content is detected from among the one or more partial contents and subjected to a reproducing process. This makes it possible to avoid omission and repetition of reproduction, resulting in improvement in operability.

Preferably, a first operation for designating a desired section is accepted by a first acceptor. The assigner assigns the first numerical value to a partial content belonging to the desired section. This will give an operator flexibility in sectioning contents, which produces a rise in operability.

More preferably, the first operation includes a start designating operation for designating the start of a section and an end designating operation for designating the end of the section independently from the start designating operation. Due to this, it is possible to form a blank section between two sections each of which defines two partial contents.

In a certain aspect, a second operation for changing a partial content to be reproduced by the first reproducer is accepted by a second acceptor. A first determiner determines whether or not a reproducing position at a time of accepting the second operation belongs to the desired section. A designator designates a different partial content for the purpose of a reproducing process by the first reproducer, depending on a result of determination by the first determiner.

By making the first acceptor accept the first operation in parallel with a recording process by the recorder, it becomes easier to designate a desired section.

Preferably, a third operation to designate any one of the one or more partial contents for the purpose of a deleting process is accepted by a third acceptor. A second determiner determines whether or not the numerical value assigned to the partial content designated by the third operation is the second numerical value. When a determination result is affirmative, the partial content designated by the third operation is deleted by a deleter. This makes it possible to save a recording capacity while preventing unreproduced partial contents from being deleted by mistake.

More preferably, a fourth operation to designate any one of the one or two or more partial contents for the purpose of a numerical value updating process is accepted by a fourth acceptor. The numerical value assigned to the partial content designated by the fourth operation is updated by a second updater to the second numerical value. A setting of the designated partial content is changed from “unreproduced” to “reproduced” without a reproducing process by the first reproducer. The partial content of which the setting has been changed is deleted by the third operation.

In a certain aspect, a message corresponding to the numerical value assigned to each of the one or more partial contents is output by an outputter in connection with an accepting process by the third acceptor. This allows the enhancement of operability.

Preferably, the content includes an audio component.

Preferably, the numerical value assigned to the partial content reproduced by the second reproducer is updated to the second numerical value by a third updater.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a structure of one embodiment of the present invention;

FIG. 2 is an illustrative view showing one example of a state where index information is assigned to continuous audio data;

FIG. 3 is an illustrative view showing one example of index information table applied to the FIG. 1 embodiment;

FIG. 4 is a flowchart showing one part of operation of a CPU applied to the FIG. 1 embodiment;

FIG. 5 is a flowchart showing another part of operation of the CPU applied to the FIG. 1 embodiment;

FIG. 6 is a flowchart showing still another part of operation of the CPU applied to the FIG. 1 embodiment;

FIG. 7 is a flowchart showing further another part of operation of the CPU applied to the FIG. 1 embodiment;

FIG. 8 is a flowchart showing another part of operation of the CPU applied to the FIG. 1 embodiment; and

FIG. 9 is a flowchart showing still another part of operation of the CPU applied to the FIG. 1 embodiment.

### DETAILED DESCRIPTION OF THE PREFERRED EMBODIMENTS

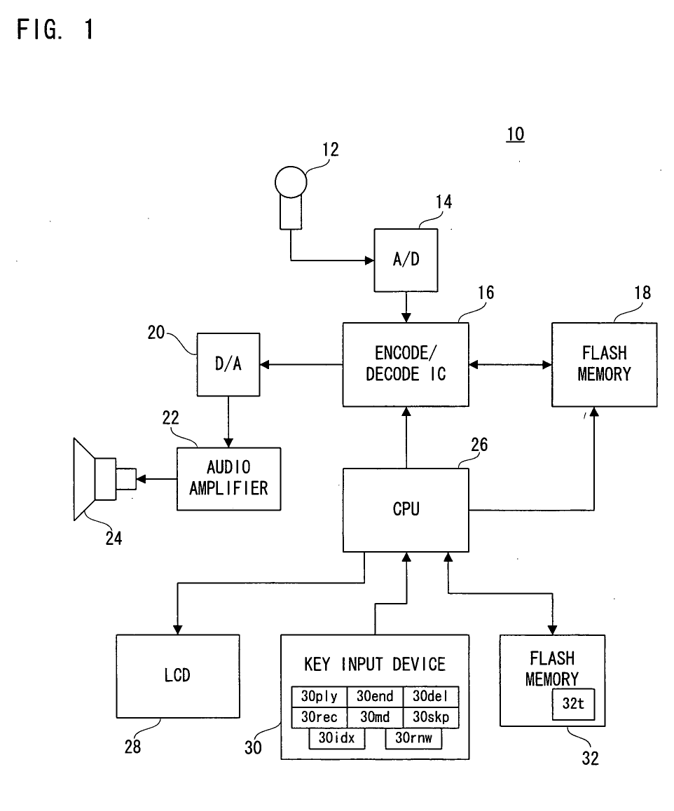

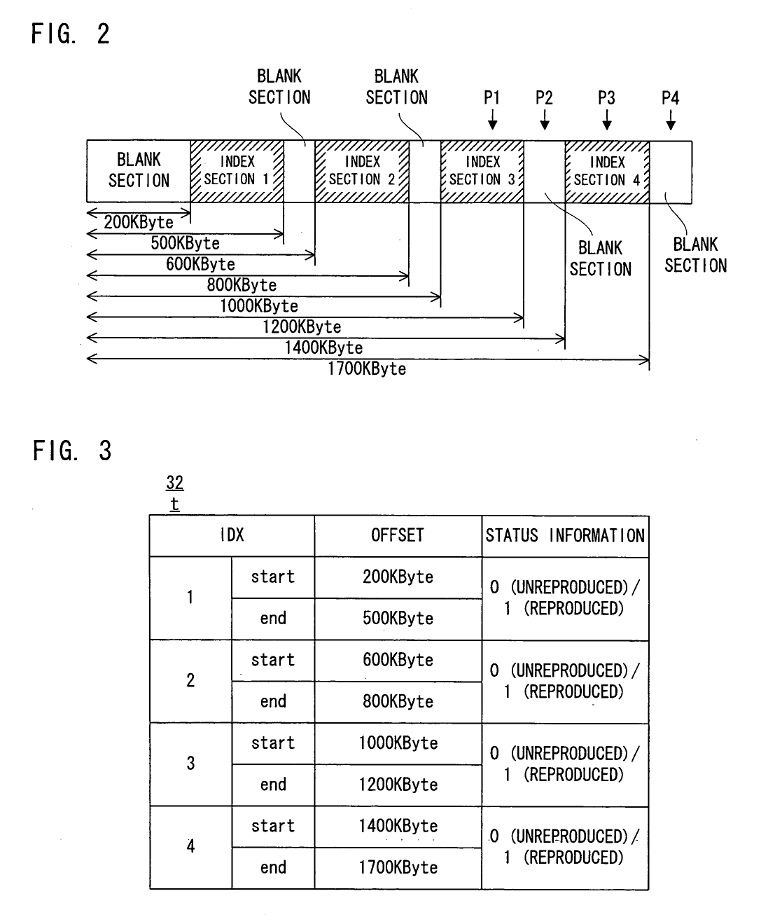

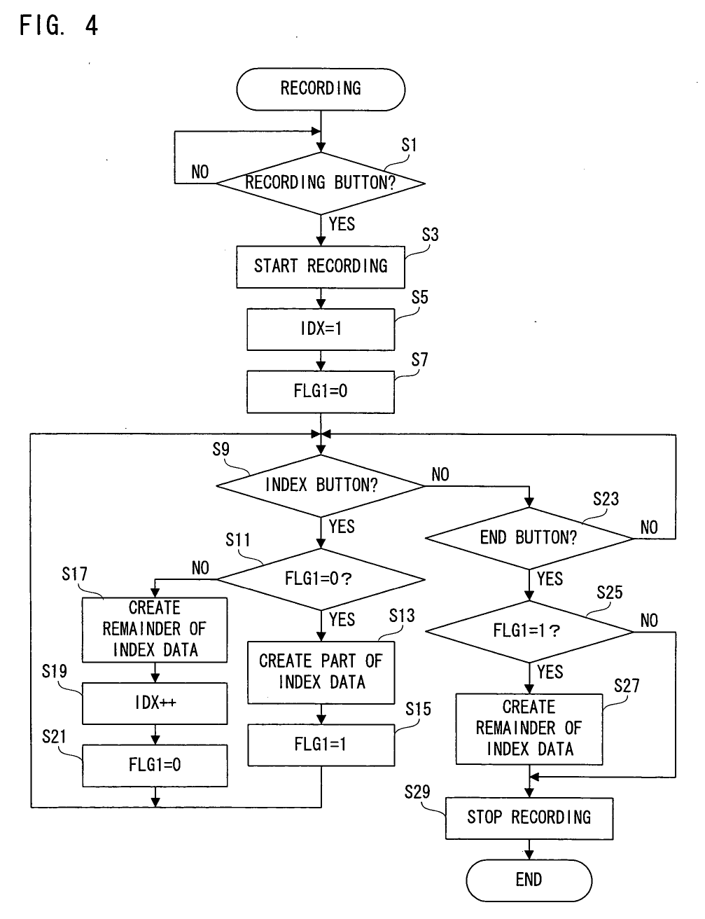

Referring to FIG. 1, a voice recorder 10 of this embodiment includes a key input device 30. When a recording mode is selected by a mode switch button 30md provided on the key input device 30 and a recording button 30rec is operated, a CPU 26 activates a microphone 12 and an A/D converter 14 and instructs an encode/decode IC 16 to start a recording process.

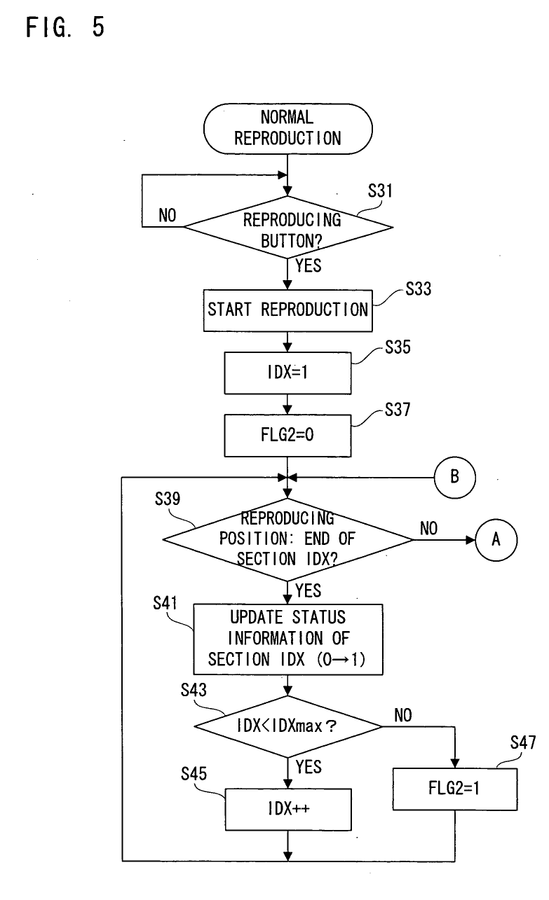

Surrounding audio is captured by the microphone 12 and converted by the A/D converter 14 into audio data as a digital signal. The encode/decode IC 16 encodes the audio data output from the A/D converter 14 and writes the encoded audio data into a flash memory 18 in such a manner as shown in FIG. 2.

When an index button 30idx is operated while a recording process is thus performed, one part of index data is created by the CPU 26 on an index table 32t shown in FIG. 3. More specifically, the CPU 26 detects an offset from a recording start position to a current recording position as a section start position, and assigns the detected offset to “start” of index number “1” shown in FIG. 3.

When the index button 30idx is operated again, another part of the index data is produced by the CPU 26. More specifically, the CPU 26 detects an offset from the recording start position to a current recording position as a section end position, and assigns the detected offset to “end” of index number “1”. The CPU 26 also assigns status information indicative of “0” to index number “1”. The status information indicates either “0” corresponding to “unreproduced” or “1” corresponding to “reproduced”. In the recording mode, the status information is set to “0”.

The index information thus completed defines an index section 1 shown in FIG. 2. That is, an index section is designated by operating the index button 30idx consecutively twice. By repeatedly operating the index button 30idx in this manner, index data to be assigned to each of index numbers “1” to “4” is created on the index table 32t, and therefore, index sections 1 to 4 are formed as shown in FIG. 2.

The designation of an index section requires two-time operation of the index button 30idx. Accordingly, blank sections not defined by index data are formed not only at the start and end of audio data but also between two adjacent index sections.

When an end button 30end is operated during the recording process, the CPU 26 deactivates the microphone 12 and the A/D converter 14 and instructs the encode/decode IC 16 to stop the recording process. The encode/decode IC 16 stops encoding the audio data and writing the data into the flash memory 18.

When a normal reproducing mode is selected by the mode switch button 30md and a play button 30ply is operated, the CPU 26 activates a D/A converter 20, an audio amplifier 22 and a speaker 24, and instructs the encode/decode IC 16 to start a reproducing process. The encode/decode IC 16 reads out audio data recorded on the flash memory 18 in sequence from the first, and decodes the read audio data. The decoded audio data is converted into an analog audio signal by the D/A converter 20 and the converted audio signal is output from the speaker 24 via the audio amplifier 22.

When the reproducing position has reached the end of an index section, the CPU 26 updates the status information corresponding to this index section (see FIG. 3) from “0” to “1”. For example, when the reproducing position has reached the end of the index section 1, the status information assigned to the index number “1” is updated to “1”.

When the skip button 30skp is operated during the reproducing process, the CPU 26 changes the reproducing position to the start of a next index section. For example, when the skip button 30skp is operated while the index section 2 is reproduced, the reproducing position is changed to the start of the index section 3. The index section 2 is not reproduced to the end, and the status information of the index section 2 remains “0”.

When the end button 30end is operated during the reproducing process, the CPU 26 deactivates the D/A converter 20, the audio amplifier 22 and the speaker 24, and instructs the encode/decode IC 16 to stop the reproducing process. The encode/decode IC 16 stops reading the audio data and decoding the read audio data.

When a skip reproducing mode is selected by the mode switch button 30md and the play button 30ply is operated, the CPU 26 activates the D/A converter 20, the audio amplifier 22 and the speaker 24, and instructs the encode/decode IC 16 to start the reproducing process, as in the case stated above.

However, the CPU 26 detects an index section of which status information indicates “0” by reference to the index table 32t, and designates the start of the detected index section as a reproducing position. As a result, in the skip reproducing mode, only audio data belonging to unreproduced index sections is reproduced. Besides, the status information of a completely reproduced index section is updated from “0” to “1”.

When an edit mode is selected by the mode switch button 30md, the CPU 26 successively outputs messages corresponding to the status information described in the index table 32t from an LCD monitor 28. When the status information indicates “0”, a text message of “unreproduced” is output. When the status information indicates “1”, a text message of “reproduced” is output.

When a renew button 30rnw is pressed while the text message of “unreproduced” is displayed, the CPU 26 updates the status information corresponding to this message from “0” to “1”. Also, when a delete button 30del is operated while the text message of “reproduced” is displayed, the CPU 26 deletes audio data of the index section corresponding to this message from the flash memory 18. Incidentally, two blank sections between which the deleted index section is put are combined to each other, thereby providing the continuity of the audio data.

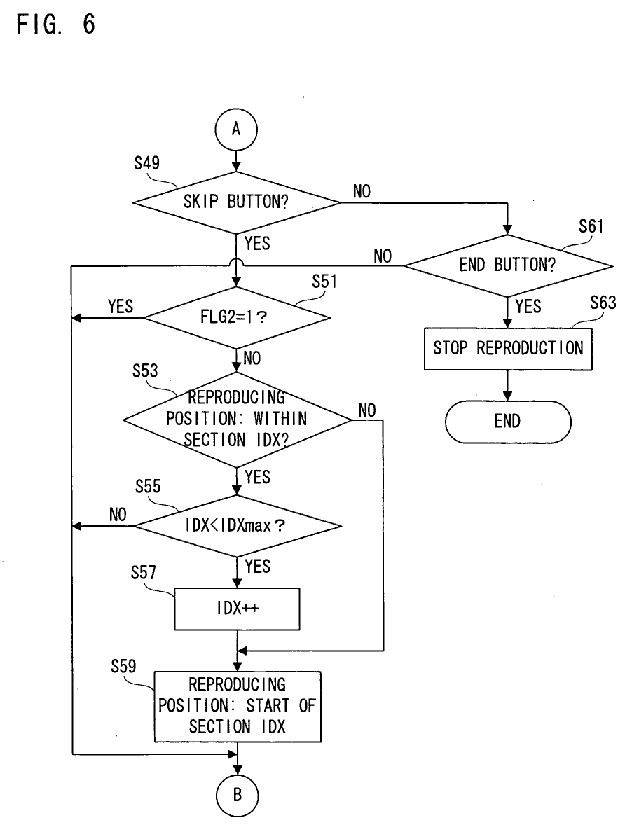

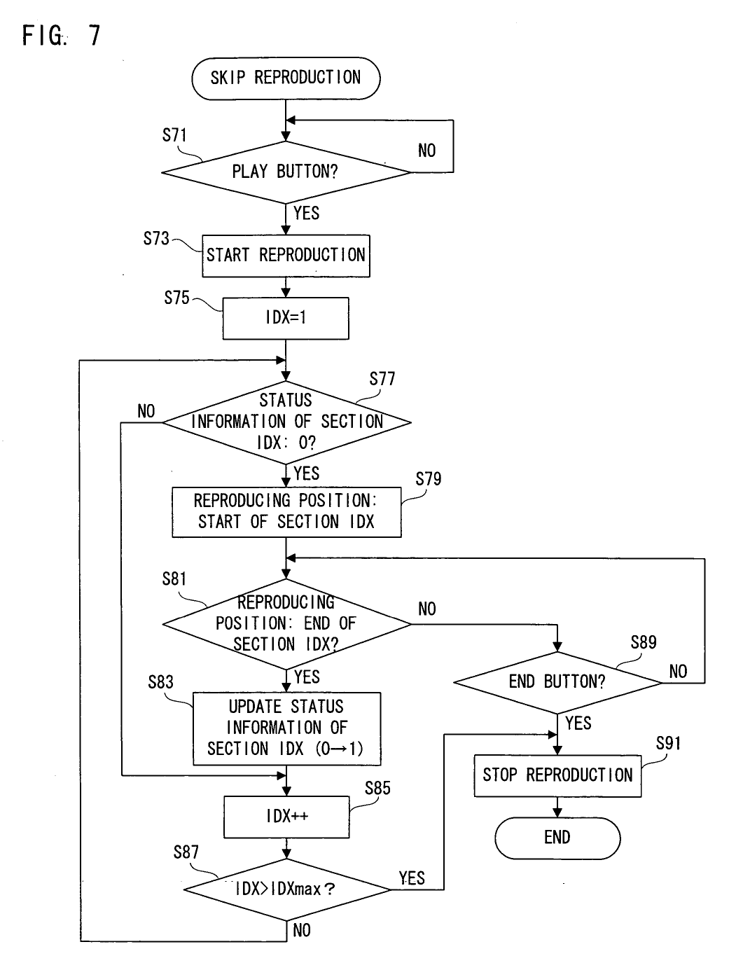

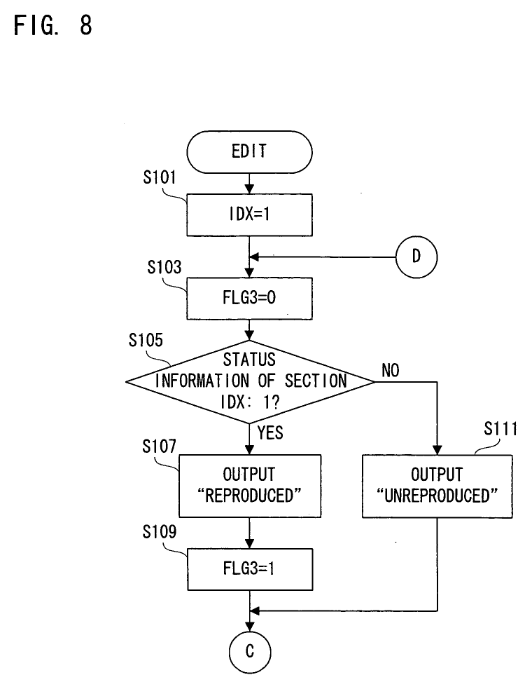

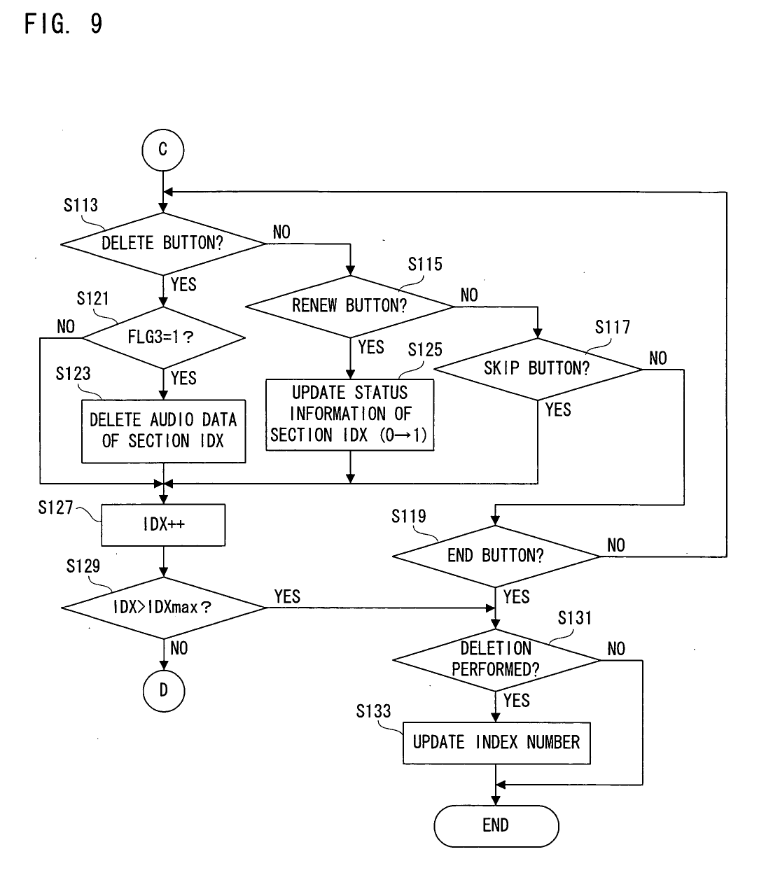

The CPU 26 performs a process according to a flowchart shown in FIG. 4 when the recording mode is selected, performs a process according to flowcharts shown in FIG. 5 and FIG. 6 when the normal reproducing mode is selected, performs a process according to a flowchart shown in FIG. 7 when the skip reproducing mode is selected, and performs flowcharts shown in FIG. 8 and FIG. 9 when the edit mode is selected. In addition, a control program corresponding to these flowcharts is stored in the flash memory 32.

Firstly, referring to FIG. 4, when the recording button 30rec is operated after selection of the recording mode, YES is determined in a step S1. In a succeeding step S3, the microphone 12 and the A/D converter 14 are activated, and the encode/decode IC 16 is instructed to start the recording process. As a consequence, the audio data is recorded on the flash memory 18.

An index number IDX is set to “1” in a step S5, and a variable FLG1 is set to “0” in a succeeding step S7. The variable FLG1 is a variable for identifying the existence of index data assigned to the index number IDX. The variable “FLG1=0” means that no index data exists, and “FLG1=1” denotes that the index data partly exists.

In a step S9, it is determined whether or not the index button 30idx has been operated. If YES, the status of the variable FLG1 is identified in a step S11. If the variable FLG1 is “0”, one part of the index data is created on the index table 32t shown in FIG. 3 in a step S13, and the variable FLG1 is updated from “0” to “1” in a step S15. By the process of step S13, an offset indicating the recording position at the instant when the index button 30idx has been operated is assigned to “start” of the index number IDX.

On the other hand, if the variable FLG1 is “1”, the remainder of the index data is created on the index table 32t in a step S17. By this process, an offset indicating the recording position at the instant when the index button 30idx has been operated is assigned to “end” of the index number IDX, and the status information “0” indicating “unreproduced” is assigned to the index number IDX.

The index number IDX is incremented in a step S19 and the variable FLG1 is returned from “1” to “0” in a step S21. Upon completion of the process of step S15 or step S21, the process returns to the step S9.

If NO in the step S9, it is determined in a step S23 whether or not the end button 30end has been operated. If the end button 30end has been operated, the status of the variable FLG1 is identified in a step S25. If the variable FLG1 is “0”, the process goes directly to a step S29. If the variable FLG1 is “1”, it is assumed that there left uncompleted index data, the process goes to a step S29 after executing the same process as that of step S17.

In the step S29, the microphone 12 and the A/D converter 14 are deactivated and the encode/decode IC 16 is instructed to stop recording. Consequently, the recording of audio data is brought to a halt. When the process of step S29 is completed, the process returns to a hierarchical upper routine.

Referring to FIG. 5 and FIG. 6, when the play button 30ply is operated after selection of the normal reproducing mode, YES is determined in a step S31. In a step S33, the D/A converter 20, the audio amplifier 22 and the speaker 24 are activated, and the encode/decode IC 16 is instructed to start the reproducing process. Accordingly, the audio data recorded on the flash memory 18 is reproduced from the start.

The index number IDX is set to “1” in a step S35, and the variable FLG2 is set to “0” in a succeeding step S37. The variable FLG2 is a variable for identifying whether or not the current reproducing position belongs to the last blank section. The variable “FLG2=0” means that the current reproducing position belongs to a section different from the last blank section, and “FLG2=1” denotes that the current reproducing position belongs to the last blank section.

In a step S39, it is determined whether or not the current reproducing position has reached the end of an index section corresponding to the index number IDX. If YES is determined here, the process moves to a step S41 to update the status information assigned to the index number IDX to “1”. In a step S43, the index number IDX is compared to a maximum index number IDXmax to which index data defining the last index section is assigned.

If the index number IDX is below the maximum index number IDXmax, the index number IDX is increment in a step S45. If the index number IDX is equal to the maximum index number IDXmax, the variable FLG2 is set to “1” in a step S47. The next index section is noticed by the process of step S45, and the process of step S47 reveals that a later reproducing position belongs to the last blank section. Upon completion of step S45 or S47, the process returns to the step S39.

If NO in the step S39, it is determined in a step S49 whether or not a skip button 30skp has been operated. If the skip button 30skp has been operated, the status of the variable FLG2 is identified in a step S51. If the variable FLG2 is “1”, the process returns to the step S39. If the variable FLG2 is “0”, the process proceeds to a step S53. In the step S53, it is determined whether or not the current reproducing position belongs to an index section corresponding to the index number IDX. If NO is determined here, the reproducing position is set to the start of the index section corresponding to the index number IDX in a step S59, and the process returns to the step S39.

If YES in the step S53, the variable IDX is compared to the maximum index number IDXmax in a step S55. If the variable IDX is below the maximum index number IDXmax, the variable IDX is incremented in a step S57, and then the process returns to the step S39 after the process of step S59. On the other hand, if the variable IDX is equal to the maximum index number IDXmax, the process returns directly to the step S39.

Thus, if the skip button 30skp is operated when the current reproducing position is a position P1 shown in FIG. 2, the processes of steps S51, S53, S55, S57 and S59 are carried out. The reproducing position is changed to the start of the index section 4. If the skip button 30skp is operated when the current reproducing position is a position P2 shown in FIG. 2, the processes of steps S51, S53, S57 and S59 are carried out. In this case as well, the reproducing position is changed to the start of the index section 4.

If the skip button 30skp is operated when the current reproducing position is a position P3 shown in FIG. 2, NO is determined in the step S55 after the processes of steps S51 and S53. At this time, the operation of the skip button 30skp is invalidated. If the skip button 30skp is operated when the current reproducing position is a position P4 shown in FIG. 2, YES is determined in the step S51. In this case as well, the operation of the skip button 30skp is invalidated.

If NO in the step S49, it is determined in a step S61 whether or not the end button 30end has been operated. If YES is determined here, the process moves to a step S63 to deactivate the D/A converter 20, the audio amplifier 22 and the speaker 24 and instruct the encode/decode IC 26 to stop the reproducing operation. As a consequence, the reproducing of the audio data is brought to a stop. When the process of step S63 has been completed, the process returns to the hierarchical upper routine.

Referring to FIG. 7, when the play button 30ply is operated in the state where the skip reproducing mode is selected, YES is determined in a step S71 and the processes similar to those of steps S33 and S35 shown in FIG. 5 are carried out in steps S73 and S75.

In a step S77, it is determined whether or not the status information assigned to the index number IDX is “0”. If NO is determined here, it is assumed the index section corresponding to the index number IDX has been reproduced, and the process proceeds directly to a step S85. If YES, it is assumed that the index section corresponding to the index number IDX is not yet reproduced, and the reproducing position is set to the start of the index section corresponding to the index number IDX in a step S79.

In a step S81, it is determined whether or not the reproducing position has reached the end of the index section corresponding to the index number IDX. If YES is determined here, the process moves to a step S83 to update the status information assigned to the index number IDX from “0” to “1”. Upon completion of the update process, the process moves to a step S85.

The index number IDX is incremented in the step S85, and it is determined in a succeeding step S87 whether or not the updated index number IDX is above the maximum index number IDXmax. If NO is determined here, the process returns to the step S77. If YES, the process proceeds to a step S91. In the step S91, the D/A converter 20, the audio amplifier 22 and the speaker 24 are deactivated, and the encode/decode IC 26 is instructed to stop the reproducing operation. When the reproducing of audio data has been thus halted, the process returns to the hierarchical upper routine.

When the end button 30end is operated during the reproducing of the index section corresponding to the index number IDX, YES is determined in a step S89 and the process goes to a step S91. As a result, the reproducing operation of the encode/decode IC 16 is brought to a halt.

Referring to FIG. 8 and FIG. 9, when the edit mode is selected, the index number IDX is set to “1” in a step S101 and the variable FLG3 is set to “0” in a step S103. The variable FLG3 is a variable for identifying the reproducing status of an index section corresponding to the index number IDX. The variable “FLG3=0” means that the index section to be noted is “unreproduced” and “FLG3=1” denotes that the index section to be noted is “reproduced”.

In a step S105, it is determined whether or not the status information assigned to the index number IDX is “1”. If YES is determined here, the process moves to a step S107 to output the text message of “reproduced” from the LCD monitor 40. In a step S109, the variable FLG3 is updated to “1”. On the other hand, if NO is determined in the step S105, the process moves to a step S111 to output the text message of “unreproduced” from the LCD monitor 40.

Upon completion of the process of step S109 or S111, it is determined in a step S113 whether or not the delete button 30dlt has been operated, it is determined in a step S115 whether or not the renew button 30rnw has been operated, it is determined in a step S117 whether or not the skip button 30skp has been operated, and it is determined in a step S119 whether or not the end button 30end has been operated.

If the delete button 30dlt has been operated, the process moves from the step S113 to a step S121 to identify the status of the variable FLG3. If the variable FLG3 is “0”, it is assumed that the index section to be noted is not reproduced, and the process proceeds directly to a step S127. On the other hand, if the variable FLG3 is “1”, the process moves to a step S123 to delete reproduced audio data belonging to the index section to be noted from the flash memory 28. However, a link is formed between two addresses between which the deleted index section is put. Therefore, audio data belonging to two blank sections between which the deleted index section is put, is consecutively reproduced at time of normal reproduction. Upon completion of this deleting process, the process moves to a step S127.

The index number IDX is incremented in the step S127, and it is determined in a succeeding step S129 whether or not the updated index number IDX is above the maximum index number IDXmax. If NO is determined here, the process returns to the step S103. If YES, the process moves to a step S131.

In the step S131, it is determined whether or not the deleting process of step S123 has been carried out. If NO is determined here, the process returns directly to the hierarchical upper routine. If YES, the index number of the index table 32t is updated before the process returns to the hierarchical upper routine. The process of step S133 provides the continuity of the index number to which the index data is assigned.

When the renew button 30rnw has been operated, the process moves from the step S115 to a step S125 to update the status information assigned to the index number IDX from “0” to “1”. Upon completion of the updating process, the process moves to the step S127. When the skip button 30skp has been operated, YES is determined in the step S117, and the process goes to the step S127. When the end button 30end has been operated, YES is determined in the step S119, and the process returns to the hierarchical upper routine after the processes of steps S131 to S133.

As understood from the above descriptions, when the recording mode is selected, surrounding audio is fetched by the microphone 12 and the corresponding audio data is recorded on the flash memory 18 by the encode/decode IC 16. When the normal reproducing mode is selected, the audio data is reproduced from the flash memory 18 by the encode/decode IC 16, and the corresponding audio signal is output from the speaker 24.

In the recording mode, the CPU 26 assigns the status information indicating “0” to each of one or more partial audio components forming the audio data (S13, S17).

However, the status information of a partial audio component reproduced in the normal reproducing mode is updated to “1” by the CPU 26 (S41). When the skip reproducing mode is selected, the CPU 26 detects a partial audio component of which the status information indicates “0” from the flash memory 18 (S77), and reproduces the detected partial audio component (S79).

Therefore, the partial audio component to which the status information “0” is assigned is a partial audio component not yet reproduced in the normal reproducing mode. In the skip reproducing mode, such an unreproduced partial audio component is detected from among the one or two or more partial audio components and subjected to a reproducing process. This makes it possible to avoid omission and repetition of reproduction and produce a rise in operability.

Also, when the edit mode is selected, the CPU 26 detects the status information assigned to each of the one or two or more partial audio components (S105), and outputs the message of “unreproduced” or “reproduced” from the LCD monitor 28 depending on the detected status information (S107, S111). When the renew button 30rnw is operated with respect to the message “unreproduced”, the status information is updated from “0” to “1” (S125). In addition, when the delete button 30dlt is operated with respect to the message “reproduced”, the corresponding partial audio component is deleted (S123).

Updating the status information by operation of the renew button 30rnw makes it possible to change the attribute of a partial audio component from “unreproduced” to “reproduced” without having to reproduce it. Also, deleting the “reproduced” partial audio component makes it possible to save the capacity of the flash memory 18.

Besides, in this embodiment, the status information of a partial audio component of which reproduction has been completed is updated from “0” to “1”. The “reproduction” referred to here includes fast-forward reproduction in addition to normal-speed reproduction.

In addition, although this embodiment assumes that audio data is assumed to be a content subjected to a recording process and a reproducing process, video data may be recorded/reproduced instead of or together with audio data. Also, audio data may be a radio program.

Furthermore, in this embodiment, the designation of an index section is accepted in parallel with a recording process. The designation of an index section may be accepted at a time different from that of a recording process, provided that this is carried out prior to a reproducing operation in the normal reproducing mode.

Although the present invention has been described and illustrated in detail, it is clearly understood that the same is by way of illustration and example only and is not to be taken by way of limitation, the spirit and scope of the present invention being limited only by the terms of the appended claims.

1. A content recording/reproducing apparatus, comprising:
a fetcher for fetching a content;
a recorder for recording the content fetched by said fetcher;
a first reproducer for reproducing the content recorded by said recorder;
an assigner for assigning a first numerical value to each of one or more partial contents forming the content recorded by said recorder prior to a reproducing process by said first reproducer;
a first updater for updating the numerical value assigned to a partial content reproduced by said first reproducer, out of the one or more partial contents, to a second numerical value;
a detector for detecting a partial content to which the first numerical value is assigned from among the one or more partial contents when a special reproducing mode is selected; and
a second producer for reproducing the partial content detected by said detector.

2. A content recording/reproducing apparatus according to claim 1, further comprising a first acceptor for accepting a first operation for designating a desired section, wherein said assigner assigns the first numerical value to a partial content belonging to the desired section.

3. A content recording/reproducing apparatus according to claim 2, wherein the first operation includes a start designating operation for designating the start of a section and an end designating operation for designating the end of the section independently from the start designating operation.

4. A content recording/reproducing apparatus according to claim 3, further comprising:
a second acceptor for accepting a second operation for changing a partial content to be reproduced by said first reproducer;
a first determiner for determining whether or not a reproducing position at a time of accepting the second operation belongs to the desired section; and
a designator for designating a different partial content depending on a result of determination by said first determiner for the purpose of a reproducing process by said first reproducer.

5. A content recording/reproducing apparatus according to claim 2, wherein said first acceptor accepts the first operation in parallel with a recording process by said recorder.

6. A content recording/reproducing apparatus according to claim 1, further comprising:
a third acceptor for accepting a third operation to designate any one of the one or more partial contents for the purpose of a deleting process;
a second determiner for determining whether or not the numerical value assigned to the partial content designated by the third operation is the second numerical value; and
a deleter for deleting the partial content designated by the third operation when a result of determination by said second determiner is affirmative.

7. A content recording/reproducing apparatus according to claim 6, further comprising:
a fourth acceptor for accepting a fourth operation to designate any one of the one or more partial contents for the purpose of a numerical value updating process; and
a second updater for updating the numerical value assigned to the partial content designated by the fourth operation to the second numerical value.

8. A content recording/reproducing apparatus according to claim 6, further comprising an outputter for outputting a message corresponding to the numerical value assigned to each of the one or two partial contents in connection with an accepting process by third acceptor.

9. A content recording/reproducing apparatus according to claim 1, wherein said content includes an audio component.

10. A content recording/reproducing apparatus according to claim 1, further comprising a third updater for updating the numerical value assigned to the partial content reproduced by said second reproducer to the second numerical value.
